(19) United States
(12) Patent Application Publication
(10) Pub. No.: US 2004/0148360 A1
(43) Pub. Date: Jul. 29, 2004

(54) Communication-link-attached persistent memory device

(75) Inventors: Pankaj Mehra, San Jose, CA (US); Sam Fineberg, Palo Alto, CA (US)

Correspondence Address: HEWLETT-PACKARD COMPANY, Intellectual Property Administration, P.O. Box 272400, Fort Collins, CO, 80527-2400, US

(73) Assignee: HEWLETT-PACKARD DEVELOPMENT COMPANY

(21) Appl. No.: 10/351,194

(22) Filed: Jan. 24, 2003

(51) Int. Cl. G06F 15/167

(52) U.S. Cl. 709/212

(57) ABSTRACT

A system is described that includes a network attached persistent memory unit. The system includes a processor node for initiating persistent memory operations (e.g., read/write). The processor unit references its address operations relative to a persistent memory virtual address space that corresponds to a persistent memory physical address space. A network interface is used to communicate with the persistent memory unit wherein the persistent memory unit has its own network interface. The processor node and the persistent memory unit communicate over a communication link such as a network (e.g., SAN). The persistent memory unit is configured to translate between the persistent memory virtual address space known to the processor nodes and a persistent memory physical address space known only to the persistent memory unit. In other embodiments, multiple address spaces are provided wherein the persistent memory unit provides translation from these spaces to a persistent memory physical address space.

### BACKGROUND

Traditionally, computers have stored their data in either memory or on other input/output (I/O) storage devices such as magnetic tape or disk. I/O storage devices can be attached to a system through an I/O bus such as a PCI (originally named Peripheral Component Interconnect), or through a network such as Fiber Channel, Infiniband, ServerNet, or Ethernet. I/O storage devices are typically slow, with access times of more than one millisecond. They utilize special I/O protocols such as small computer systems interface (SCSI) protocol or transmission control protocol/internet protocol (TCP/IP), and they typically operate as block exchange devices (e.g., data is read or written in fixed size blocks of data). A feature of these types of storage I/O devices is that they are persistent such that when they lose power or are re-started they retain the information stored on them previously. In addition, I/O storage devices can be accessed from multiple processors through shared I/O networks, even after some processors have failed.

System memory is generally connected to a processor through a system bus where such memory is relatively fast with guaranteed access times measured in tens of nanoseconds. Moreover, system memory can be directly accessed with byte-level granularity. System memory, however, is normally volatile such that its contents are lost if power is lost or if a system embodying such memory is restarted. Also, system memory is usually within the same fault domain as a processor such that if a processor fails the attached memory also fails and may no longer be accessed.

Prior art systems have used battery-backed dynamic random access memory (BBDRAM), solid-state disks, and network-attached volatile memory. Prior BBDRAM, for example, may have some performance advantages over true persistent memory. It is not, however, globally accessible. Moreover, BBDRAM lies within the same fault domain as an attached CPU such that the BBDRAM will be rendered inaccessible in the event of a CPU failure or operating system crash. Accordingly, BBDRAM is often used in situations where all system memory is persistent so that the system may be restarted quickly after a power failure or reboot. BBDRAM is still volatile during long power outages such that alternate means must be provided to store its contents before batteries drain. Additionally, RDMA attachment of BBDRAM is not known to exist. Importantly, this use of BBDRAM is very restrictive and not amenable for use in network-attached persistent memory applications, for example.

Battery-backed solid-state disks (BBSSD) have also been proposed for other implementations. These BBSSDs provide persistent memory, but functionally they emulate a disk drive. An important disadvantage of this approach is the additional latency associated with access to these devices through I/O adapters. This latency is inherent in the block-oriented and file-oriented storage models used by disks and, in turn, BBSSDs. They run through a sub-optimal data path wherein the operating system is not bypassed. While it is possible to modify solid-state disks to eliminate some shortcomings, inherent latency cannot be eliminated because performance is limited by the I/O protocols and their associated device drivers. As with BBDRAM, additional technologies are required for dealing with loss of power for extended periods of time.

### SUMMARY

The present disclosure describes a persistent memory device that combines the durability and recoverability of storage I/O with the speed and fine-grained access of system memory. Like storage, its contents can survive the loss of power or system restart. Like remote memory, it is accessed across a SAN. However, unlike directly-connected memory, the device can continue to be accessed even after a processor accessing it has failed.

Remote Direct Memory Access (RDMA) is a key capability that distinguishes SANs from other classes of networks; it supports continuous-use memory semantics even when the memory is remotely located (i.e., not directly connected to the processor). SANs are therefore also known as RDMA-enabled networks. They characteristically allow fast zero-copy memory operations at byte granularity.

Network-attached persistent memory devices typically employ disk-like persistence characteristics where the contents of the memory must survive not only power failures but also operating system crashes, other software failures, hardware or software upgrades, and system maintenance reboots. The present teachings are unique in their use of persistent (or non-volatile) memory, which places very different sets of design and implementation constraints compared to volatile memory. For instance, the management of meta-data (that is, data on the state of memory) as well as the management of information for translating from virtual to physical addresses is quite different in the two cases. Moreover, the present teachings are unique in their attachment of persistent memory to an RDMA-enabled network using RDMA read and write operations.

In one implementation, a system includes a network attached persistent memory unit. The system includes a processor node for initiating memory operations such as read and write operations. The processor unit references its address operations relative to a virtual address space that corresponds to a persistent memory address space. The processor node further includes a network interface used to communicate to the persistent memory unit wherein the persistent memory unit has its own network interface. Accordingly, the processor node and the persistent memory unit communicate over a communication link such as a network and preferrably a system area network. The persistent memory unit is further configured to translate between the virtual address space known to the processor nodes and a physical address space known only to the persistent memory unit. In other embodiments multiple address spaces are provided wherein the persistent memory unit also provides translation from these multiple address spaces to physical address spaces.

In other embodiments, the translation from persistent memory virtual addresses to persistent memory physical addresses occurs within the respective processor nodes. In yet other embodiments, that translation occurs within either the links, ports, switches, routers, bridges, firmware, software or services associated with the SAN. The present teachings only assume that the mapping information required for such translation be maintained consistent with the data stored in persistent memory, that an entity can efficiently carry out address translation using the stored mapping information, and that the entity and the required mapping information will be available any time information needs to be recovered from the persistent memory.

In yet other embodiments, other types of networks are used such as ServerNet, GigaNet, Infiniband, PCI Express, RDMA-enabled Ethernet, and Virtual Interface Architecture (VIA) networks. Moreover, various types of persistent memory are used such as magnetic random access memory (MRAM), magneto-resistive random access memory (MRRAM), polymer ferroelectric random access memory (PFRAM), ovonics unified memory (OUM), and FLASH memory.

These and other embodiments will be understood upon an understanding of the present disclosure by one of ordinary skill in the art to which it pertains.

### BRIEF DESCRIPTION OF THE DRAWINGS

The accompanying drawings, which are incorporated in and form a part of this specification, illustrate preferred embodiments of the invention and, together with the description, serve to explain its principles.

FIG. 1 is a block diagram of a system that includes a network attached persistent memory unit (nPMU).

FIG. 2 is a block diagram of an embodiment of a network attached persistent memory unit (nPMU).

FIG. 3 is a block diagram of an embodiment of a network attached persistent memory unit (nPMU) using battery backup.

FIG. 4 is a block diagram illustrating mappings from a persistent memory virtual address space to a persistent memory physical address space.

FIG. 5 is a block diagram of an embodiment of a network attached persistent memory unit (nPMU) having one persistent memory virtual address space.

FIG. 6 is a block diagram of an embodiment of a network attached persistent memory unit (nPMU) having multiple persistent memory virtual address spaces.

FIG. 7 is a block diagram of an illustrative computer system on which a network attached persistent memory unit (nPMU) is implemented.

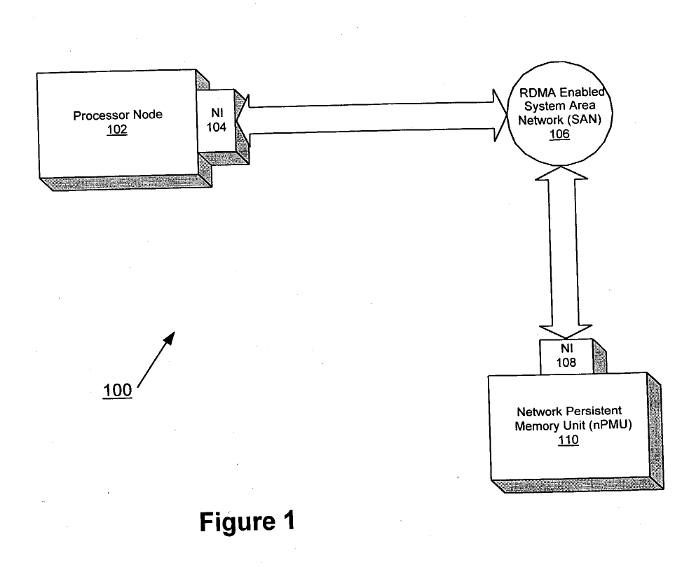

### DETAILED DESCRIPTION OF THE PREFERRED EMBODIMENTS

Whereas prior art systems have used persistent memory only in the context of block-oriented and file-oriented I/O architectures with their relatively large latencies, the present teachings describe memory that is persistent like traditional I/O storage devices, but that can be accessed like system memory with fine granularity and low latency. As shown in FIG. 1, a system 100 using network attached persistent memory comprises a network-attached persistent memory unit (nPMU) 110 that can be accessed by one or more processor nodes 102 through an RDMA-enabled system area network (SAN) 106. In order to access the persistent memory of nPMU 110, software running on the processor node 102 initiates remote read or write operations through the processor node's network interface (NI) 104. In this manner read or write commands are carried on RDMA-enabled SAN 106 to the nPMU's network interface (NI) 108. Accordingly, after processing, the appropriate data is communicated over the RDMA-enabled SAN 106. In addition to RDMA data movement operations, nPMU 110 can be configured to respond to various management commands to be described below. In a write operation initiated by processor node 102, for example, once data have been successfully stored in the nPMU, they are durable and will survive a power outage or processor node 102 failure. In particular, memory contents will be maintained as long as the nPMU continues to function correctly, even after the power has been disconnected for an extended period of time, or the operating system on processor node 102 has been rebooted.

In this embodiment, processor node 102 is a computer system comprising at least one central processing unit (CPU) and memory wherein the CPU is configured to run an operating system. Processor node 102 is additionally configured to run application software such as database programs. Processor node 102 uses SAN 106 to communicate with other processor nodes 102 as well as with devices such as nPMU 110 and I/O controllers (not shown).

In one implementation of this embodiment, an RDMA-enabled SAN is a network capable of performing byte-level memory operations such as copy operations between two processor nodes, or between a processor node and a device, without notifying the CPU of processor node 102. In this case, SAN 106 is configured to perform virtual to physical address translation in order to enable the mapping of contiguous network virtual address spaces onto discontiguous physical address spaces. This type of address translation allows for dynamic management of nPMU 110. Commercially available SANs 106 with RDMA capability include, but are not limited to, ServerNet, GigaNet, Infiniband, and all Virtual Interface Architecture compliant SANs.

Processor nodes 102 are generally attached to a SAN 106 through the NI 110, however, many variations are possible. More generally, however, a processor node need only be connected to an apparatus for communicating read and write (or load and store) operations. For example, in another implementation of this embodiment, processor nodes 102 are various CPUs on a motherboard and, instead of using a SAN, a data bus is used, for example a PCI bus. It is noted that the present teachings can be scaled up or down to accommodate larger or smaller implementations as needed.

Network interface (NI) 108 is communicatively coupled to nPMU 110 to allow for access to the persistent memory contained with nPMU 110. Many technologies are available for the various components of FIG. 1, including the type of persistent memory. Accordingly, the embodiment of FIG. 1 is not limited to a specific technology for realizing the persistent memory. Indeed, multiple memory technologies, including magnetic random access memory (MRAM), magneto-resistive random access memory (MRRAM), polymer ferroelectric random access memory (PFRAM), ovonics unified memory (OUM), BBDRAM, and FLASH memories of all kinds, are appropriate. Whereas BBSSDs perform block level transfers, this approach allows for finer granularity of memory access, including byte-level memory access. Notably, memory access granularity can be made finer or coarser using this approach. Where SAN 106 is used, memory should be fast enough for RDMA access. In this way, RDMA read and write operations are made possible over SAN 106. Where another type of communication apparatus is used, the access speed of the memory used should also be fast enough to accommodate the communication apparatus. It should be noted that persistent information is provided to the extent the persistent memory in use may hold data. For example, in many applications, persistent memory may be required to store data regardless of the amount of time power is lost; whereas in another application, persistent memory may only be required for a few minutes or hours.

In conjunction with this approach, memory management functionality is provided for creating single or multiple independent, indirectly-addressed memory regions. Moreover, nPMU meta-data is provided for memory recovery after loss of power or processor failure. Meta information includes, for example, the contents and the layout of the protected memory regions within an nPMU. In this way, the nPMU stores the data and the manner of using the data. When the need arises, the nPMU can then allow for recovery from a power or system failure.

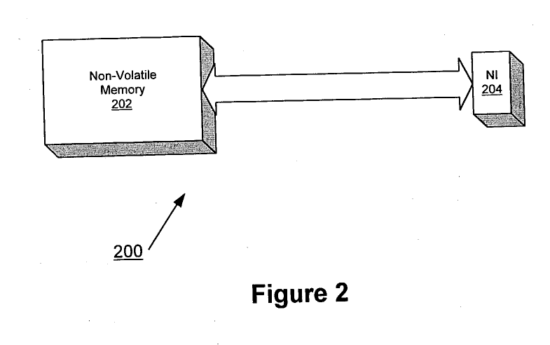

Shown in FIG. 2 is an embodiment of nPMU 200 that uses non-volatile memory 202 communicatively coupled to NI 204 via a communications link such as a bus. Here, non-volatile memory 202 can be, for example, MRAM or Flash memory. NI 204 does not initiate its own RDMA requests, but instead NI 204 receives management commands from the network and carries out the requested management operations. Specifically, nPMU 200 translates the address on incoming requests and then carries out the requested operation. Further details on command processing will be discussed below.

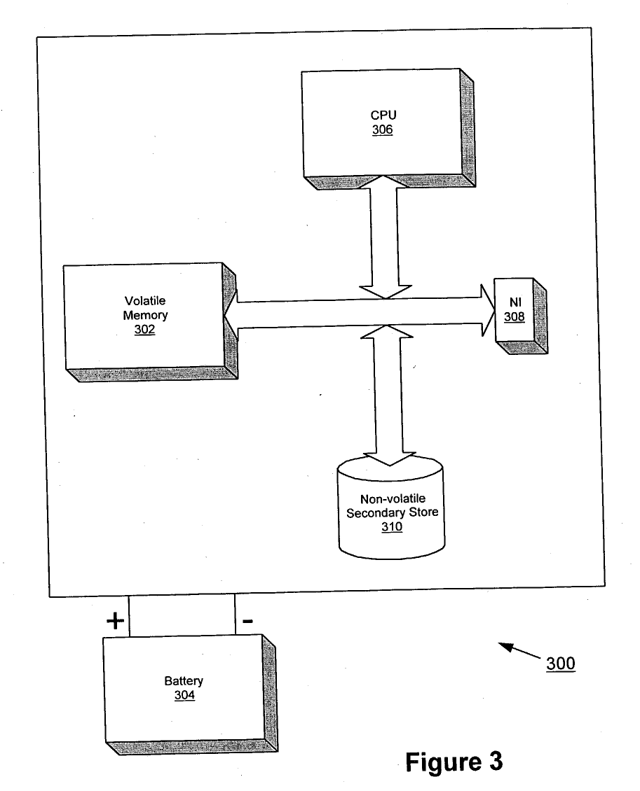

Shown in FIG. 3 is another embodiment of nPMU 300 using a combination of volatile memory 302 with battery 304 and a non-volatile secondary store 310. In this embodiment, when power fails, the data within volatile memory 302 is preserved using the power of battery 304 until such data can be saved to non-volatile secondary store 310. Non-volatile secondary store can be, for example, a magnetic disk or slow FLASH memory. For nPMU 300 to operate properly, the transfer of data from volatile memory 302 to non-volatile secondary memory store 310 should occur without external intervention or any further power other than that from battery 304. Accordingly, any required tasks should be completed before battery 304 can discharge. As shown, nPMU 300 includes optional CPU 306 running an embedded operating system. Accordingly, the backup task (i.e., data transfer from volatile memory 302 to non-volatile secondary memory store 310) can be performed by software running on CPU 306. NI 308 is also included to initiate RDMA requests under the control of software running on CPU 306. Here again, CPU 306 receives management commands from the network and carries out the requested management operation.

An nPMU such as nPMU 200 or 300 has to be a managed entity in order to facilitate resource allocation and sharing. In this embodiment, nPMU management is carried out by a persistent memory manager (PMM). The PMM can be located within the nPMU or outside the nPMU such as on one of the previously described processor nodes. When a processor node needs to allocate or de-allocate persistent memory of the nPMU, or when it needs to use an existing region of persistent memory, the processor node first communicates with the PMM to perform requested management tasks. Note that because an nPMU is durable (like a disk), and because the nPMU maintains a self-describing body of persistent data, meta-data related to existing persistent memory regions must be stored on the nPMU device itself. The PMM must therefore perform management tasks in a manner that will always keep the meta-data on the nPMU consistent with the persistent data stored on the nPMU, so that the nPMU's stored data can always be interpreted using the nPMU's stored meta-data and thereby recovered after a possible system shutdown or failure. In this way, an nPMU maintains in a persistent manner not only the data being manipulated but also the state of the processing of such data. Upon a need for recovery, the system 100 using an nPMU 110 is thus able to recover and continue operation from the memory state in which a power failure or operating system crash occurred.

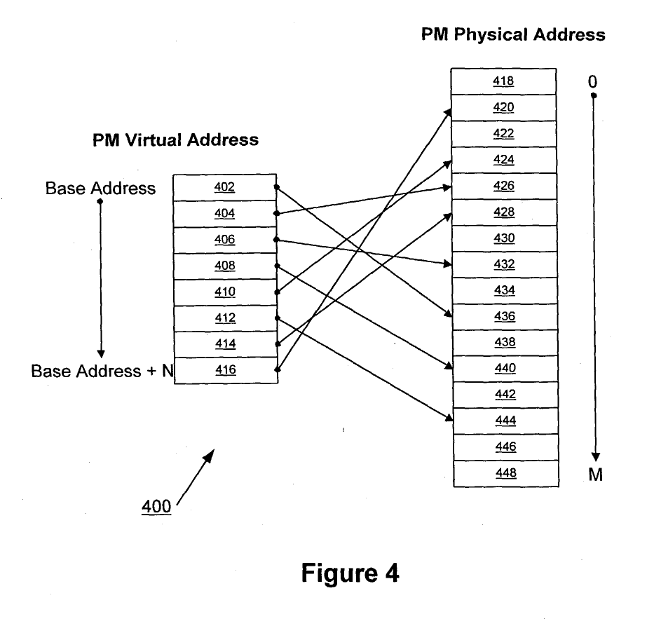

As described with reference to FIG. 1, SAN 106 provides basic memory management and virtual memory support. In such an implementation, the PMM must be able to program the logic in NI 108 of nPMU 110 in order to enable remote read and write operations, while simultaneously protecting the persistent memory from unauthorized or inadvertent accesses by all except a select set of entities on SAN 106. Moreover, as shown in FIG. 4, an NPMU can support virtual-to-physical address translation. For example, a continuous virtual address space such as persistent memory (PM) virtual addresses 402 through 416 can be mapped or translated to discontinuous persistent memory physical addresses 418-448. PM virtual addresses are referenced relative to a base address through N incremental address. Such PM virtual addresses, however, correspond to discontiguous PM physical addresses. As shown, PM virtual address 402 can actually correspond to a PM physical address 436. Accordingly, the nPMU must be able to provide the appropriate translation from the PM virtual address space to the PM physical address space and vice versa. In this way, the translation mechanism allows the nPMU to present contiguous virtual address ranges to processor nodes, while still allowing dynamic management of the nPMUs physical memory. This is particularly important because of the persistent nature of the data on an nPMU. Due to configuration changes, the number of processes accessing a particular nPMU, or possibly the sizes of their respective allocations, may change over time. The address translation mechanism allows the nPMU to readily accommodate such changes without loss of data. The address translation mechanism further allows easy and efficient use of persistent memory capacity by neither forcing the processor nodes to anticipate future memory needs in advance of allocation nor forcing the processor nodes to waste persistent memory capacity through pessimistic allocation.

With reference back to FIG. 1, the ServerNet SAN operating in its native access validation and translation/block transfer engine (AVT/BTE) mode is an example of a single-address space SAN 106. Each target on such SAN presents the same, flat network virtual address space to all of its RDMA-request initiators, such as processor nodes 102. Network virtual address ranges are mapped by the target from PM virtual address to PM physical address ranges with page granularity. Network PM virtual address ranges can be exclusively allocated to a single initiator (e.g., processor node 102), and multiple PM virtual addresses can point to the same physical page.

When processor node 102 requests the PMM to open (i.e., allocate and then begin to use) a region of persistent memory in an nPMU, the nPMU's NI 108 is programmed by the PMM to allow processor node 102 to access the appropriate region. This programming allocates a block of network virtual addresses and maps (i.e., translates) them to a set of physical pages in physical memory. The range of PM virtual addresses can then be contiguous regardless how many pages of PM physical address are to be accessed. The physical pages, however, can be anywhere within the PM physical memory. Upon successful set-up of the translation, the PMM notifies the requesting processor node 102 of the PM virtual address of the contiguous block. Once open, processor node 102 can access nPMU memory pages by issuing RDMA read or write operations to the NPMU.

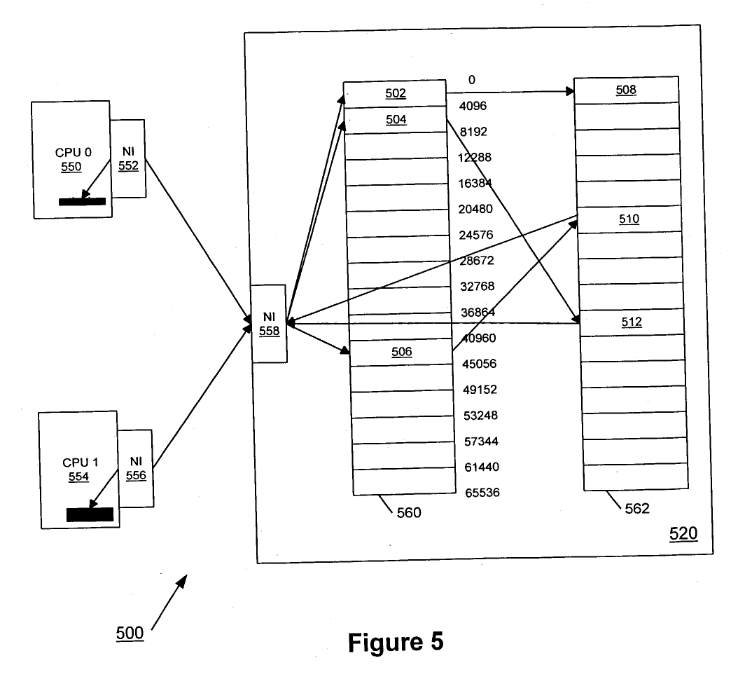

With reference now to FIG. 5, nPMU 520 operations will be described in the context of a single virtual address space. Shown is a single PM virtual address space 560 that translates to a PM physical address space 562. Once a range of persistent memory is open, CPU 0 550 can access such range of persistent memory in conjunction with the operation of NI 552 and NI 558. The PMM opens a range of persistent memory by making available to a CPU a range of virtual addresses. In requesting access to an open range of PM virtual address space, CPU 0 550 passes a command (e.g., read or write) through NI 552 to NI 558. In proper operation, CPU 0 550 can only access a specified range of PM virtual addresses. Accordingly, as part of its PMM-configured functionality, the NI 558 first validates the ability of CPU 0 550 to target the requested PM virtual address 560. If within the allowed range of CPU 0 550, NI 558 then performs the requisite address translation, and finally carves out the requested operation (e.g., read or write) against the PM physical address 562.

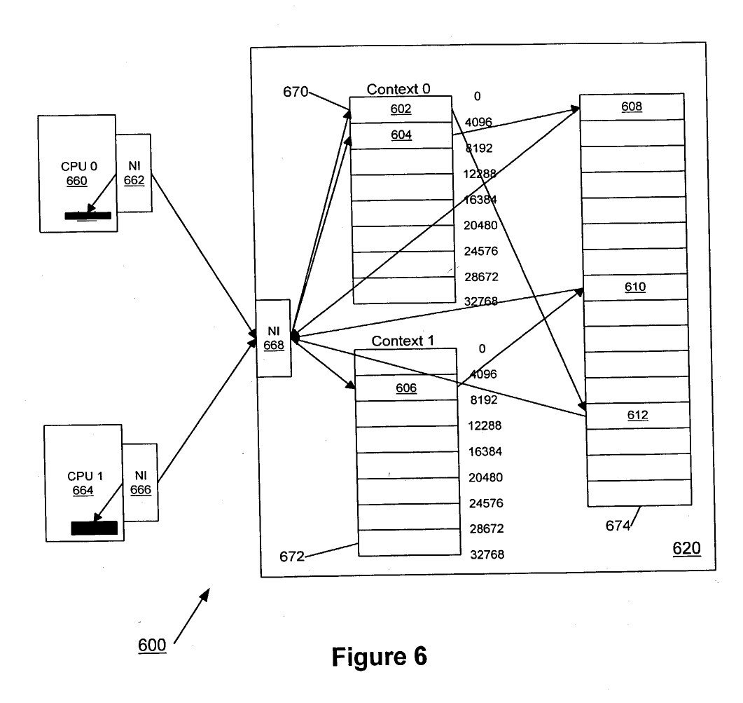

As shown in FIG. 6, nPMU 620 can also accommodate multiple address contexts (spaces) 670 and 672 with their respective PM virtual address spaces and translates each space independently into the PM physical address space 674. SANs that implement multiple address spaces include VI Architecture (VIA) SANs, which in turn include GigaNet and ServerNet II (in VIA mode), as well as Infiniband. There are similarities between nPMU 620 of FIG. 6 and nPMU 520 of FIG. 5. In nPMU 620, however, a PMM needs to discern first among the multiple address contexts 670 and 672 and then translate the virtual address contexts 670 and 672 to the appropriate PM physical address 674.

In this embodiment, NI 668 is designed for user-mode as well as kernel-mode access to PM virtual memory and, in turn, PM physical memory. Accordingly, NI 668 provides the process-equivalent virtual addresses. In this way, many independent network virtual address spaces can be made available. Whereas only two address contexts are shown, many more are possible. In fact, to the extent that the present teachings are applicable in internet applications, many thousands of address contexts are possible. To specify a particular address space, an RDMA command (e.g., read or write) specifies a context identifier along with the desired virtual address. NI 668 can therefore accommodate various processor nodes (e.g., CPU 0 660 and CPU 1 664) to share the same context identifier. Moreover, separate virtual pages from different contexts can translate to the same physical memory page.

As before, when a node opens a region of persistent memory for access, NI 668 is programmed by its PMM. Also, NI 668 verifies that the requesting processor node has access to the requested virtual address. Here, however, the programming creates a context in the NI 668. The context includes a block of network virtual addresses that are translated to a set of physical pages. For example, PM virtual address 602 of context 0 670 translates to PM physical address 612; and PM virtual address 606 of context 1 672 translates to PM physical address 610. In an embodiment, the PM virtual addresses are contiguous regardless of the number of PM physical pages allocated. The physical pages, however, can be located anywhere within the PM physical memory.

The further functionality of the present approach as shown, for example, in FIG. 1 can now be understood. For example, once processor node 102 has communicated with the PMM to open a memory region, it can then directly access the memory of nPMU 110 without again going through the PMM. For example, a remote read command provides a starting network virtual address and offset as well as a context identifier (in the case of multiple address spaces). For proper operation, this address range should be within the range allocated by the PMM. Processor node 102 provides to NI 104 a remote read command containing a pointer to a local physical memory location at node 102. NI 104 in the requesting processor node 102 then transmits the remote read command to NI 108 of nPMU 110 via SAN 106. NI 108 translates the starting network virtual address to a physical address within nPMU 110 using translation tables associated with the region. By means of NI 108, nPMU 110 then returns data to the reading processor node starting at the translated physical address. NI 108 continues translating addresses even if nPMU 110 reaches page boundaries since the physical pages of contiguous PM virtual addresses do not necessarily translate to contiguous PM physical addresses. When the read command is completed, NI 104 marks the read transfer as completed. Moreover, any waiting processes can be notified and, in turn, processed.

A remote write to persistent memory is similar. Processor node 102 provides a starting PM network virtual address and offset as well as a context identifier (in the case of multiple address spaces) for nPMU 110. As before, the PM network virtual address range must fall within the allocated range. Processor node 102 also provides a pointer to the physical address of the data to be transmitted. NI 104 in processor node 102 then issues a remote write command to NI 108 in nPMU 110 and begins sending data. NI 108 translates the start address to a physical address in nPMU 110 using translation tables associated with the region. Also, nPMU 110 stores data starting at the translated physical address. NI 108 continues translating addresses even if nPMU 110 reaches page boundaries since the physical pages of contiguous PM network virtual addresses do not necessarily translate to contiguous PM physical addresses. When the write command is completed, NI 104 marks the write transfer as completed. Any waiting processes can then be notified and, in turn, processed.

It should be noted that in latency testing of the nPMU according to the present teachings, it was found that memory accesses could be achieved well within 80 microseconds which compares very favorably to I/O operations requiring over 800 microseconds. Indeed this result is possible because the latencies of I/O operations, including their necessary interrupts, are avoided. The nPMU according to the present teachings therefore has the persistence of storage with the fine-grained access of system memory.

Various applications exist for nPMUs including applications to accelerate disk reads and writes. Also, nPMUs can facilitate recovery from a power or processor failure. Because of the inherent differences between read and write operations, nPMU provide a more significant improvement in write operations than in read operations since nPMUs use slower and smaller memory across a network than system RAM over a much faster bus. Whereas, data structures that are to be read frequently may be cached in system RAM, even if a copy exists in nPMU, less often used data structures are appropriate for an nPMU.

For example, database locks held on a transaction-by-transaction basis are appropriate for storage in an nPMU. By tracking updated locks held by transactions in an nPMU, recovery from unplanned outages—and perhaps planned transaction manager shutdowns—can be accelerated. Moreover, an nPMU can facilitate the advent of new lock types that persist across failure, thereby guarding the database resources left in an inconsistent state by transactions in process at the time of a crash.

A physical redo cache is also appropriate for an nPMU implementation. Maintaining a cache of database blocks dirtied (that is partially processed), but not flushed before the second-to last control point, speeds physical redo during volume recovery using fuzzy check pointing. In an implementation, such a cache is pruned as each control point progresses. During recovery, instead of reading disk volumes, often randomly, for data associated with redo records in an audit trail, by consulting the redo cache in an nPMU, recovery can be achieved much faster. This can be especially important when database caches are large and transactions are relatively small yet occurring at a high rate. In such scenarios, a large amount of audit information can build up between successive control points that can, nonetheless, be stored in an nPMU for expedited recovery.

An nPMU can also provide for efficient database commits through the use of persistent log tail. For example, instead of waiting for disk write operations corresponding to auxiliary audit trails to flush before committing database transactions, an nPMU can allow for database commits upon writing to the nPMU and not having to wait for other flushing operations. Since an nPMU can have better than 10 times lower latency than disk storage, database transaction latencies can be significantly shortened. Moreover, transaction throughput is likewise improved. For example, to the extent information must nonetheless be committed to a disk, an NPMU can accumulate a significantly larger amount of information and, in turn, more efficiently write it to the disk.

Database queues and event processing can also be improved through the use of an nPMU. For example, queues and events can be maintained using list data structures in an nPMU in order to avoid any failures or stalls in inter-enterprise or enterprise-wide deployments. Maintaining events and queues in an nPMU enables smooth workflow processing and timely handling of events, even when a CPU that is actively processing information encounters a failure.

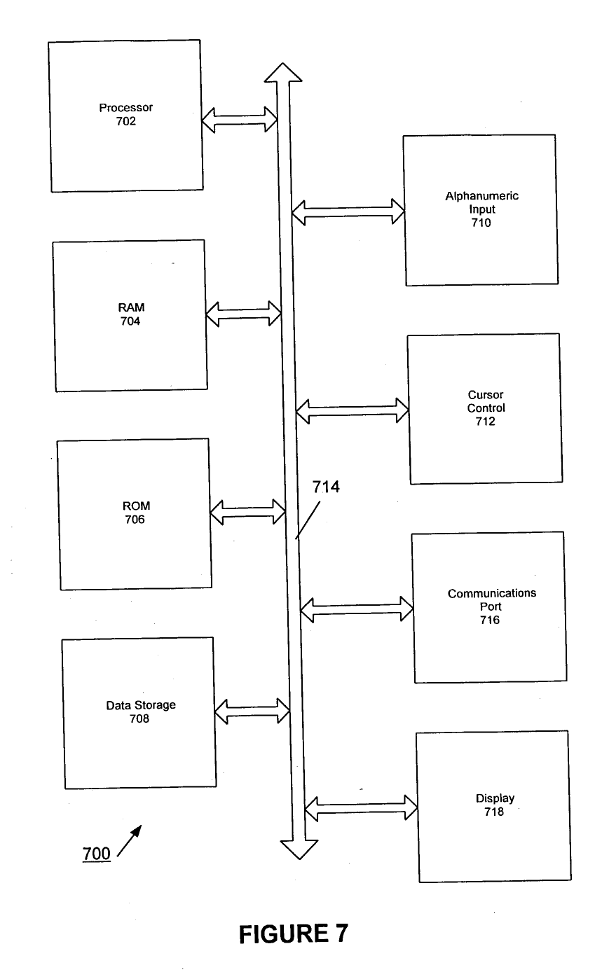

In one embodiment, the present approach is practiced on a computer system 700 as shown in FIG. 7. Referring to FIG. 7, an exemplary computer system 700 (e.g., personal computer, workstation, mainframe, etc.) upon which the present teachings may be practiced is shown. Computer system 700 is configured with a data bus 714 that communicatively couples various components. As shown in FIG. 7, processor 702 is coupled to bus 714 for processing information and instructions. A computer readable volatile memory such as RAM 704 is also coupled to bus 714 for storing information and instructions for the processor 702. Moreover, computer-readable read only memory (ROM) 706 is also coupled to bus 714 for storing static information and instructions for processor 702. A data storage device 708 such as a magnetic or optical disk media is also coupled to bus 714. Data storage device 708 is used for storing large amounts of information and instructions. An alphanumeric input device 710 including alphanumeric and function keys is coupled to bus 714 for communicating information and command selections to the processor 702. A cursor control device 712 such as a mouse is coupled to bus 714 for communicating user input information and command selections to the central processor 702. Input/output communications port 716 is coupled to bus 714 for communicating with a network, other computers, or other processors, for example. Display 718 is coupled to bus 714 for displaying information to a computer user. Display device 718 may be a liquid crystal device, cathode ray tube, or other display device suitable for creating graphic images and alphanumeric characters recognizable by the user. The alphanumeric input 710 and cursor control device 712 allow the computer user to dynamically signal the two dimensional movement of a visible symbol (pointer) on display 718.

While various embodiments and advantages have been described, it will be recognized that a number of variations will be readily apparent. For example, in implementing persistent memory, many technologies are available. Thus, the present approach may be widely applied consistent with the disclosure herein and the claims which follow.

What is claimed is:

1. A system with a communication-link-attached persistent memory, comprising:
a communication link;
a processor node for initiating persistent memory operations against a persistent memory virtual address space wherein the processor node is communicatively coupled to the communication link via a first interface; and
a persistent memory unit communicatively coupled to the communication link via a second interface, wherein the persistent memory unit is configured to translate between the persistent memory virtual address space and a persistent memory physical address space within the communication-link-attached persistent memory.

2. The system of claim 1, wherein the processor node includes a central processing unit.

3. The system of claim 1, wherein the communication link is selected from a group consisting of a network and a bus.

4. The system of claim 3, wherein the network is selected from a group consisting of a system area network, a ServerNet network, a GigaNet network, an Infiniband network, Infiniband, PCI Express, Ethernet, RDMA-enabled Ethernet, and a Virtual Interface Architecture (VIA) network.

5. The system of claim 4, wherein the system area network is configured to implement remote direct memory access.

6. The system of claim 1, wherein the communication-link-attached persistent memory is selected from a group consisting of magnetic random access memory, magneto-resistive random access memory, polymer ferroelectric random access memory, ovonics unified memory, FLASH memory, and battery backed volatile memory.

7. A system with a communication-link-attached persistent memory, comprising:
a communication link;
a plurality of processor nodes for initiating persistent memory operations based on a plurality of persistent memory virtual address spaces wherein the plurality of processor nodes, via respective first interfaces, is communicatively coupled to the communication link; and
a persistent memory unit communicatively coupled to the communication link via a second interface, wherein the persistent memory unit is configured to translate between the plurality of persistent memory virtual address spaces and a persistent memory physical address space within the communication-link-attached persistent memory.

8. The system of claim 7, wherein the plurality of processor node includes a central processing unit.

9. The system of claim 7, wherein the communication link is selected from a group consisting of a network and a bus.

10. The system of claim 9, wherein the network is selected from a group consisting of a system area network, a ServerNet network, a GigaNet network, an Infiniband network, Infiniband, PCI Express, Ethernet, RDMA-enabled Ethernet, and a Virtual Interface Architecture (VIA) network.

11. The system of claim 10, wherein the system area network is configured to implement remote direct memory access

12. The system of claim 7, wherein the communication-link-attached persistent memory is selected from a group consisting of magnetic random access memory, magneto-resistive random access memory, polymer ferroelectric random access memory, ovonics unified memory, FLASH memory, and battery backed volatile memory.

13. A system with a communication-link-attached memory, comprising:
a communication link;
a processor node for initiating persistent memory operations against a persistent memory virtual address space wherein the processor node is communicatively coupled to the communication link via a first interface; and
a persistent memory unit communicatively coupled to the communication link via a second interface, wherein the persistent memory unit is configured to translate between the persistent memory virtual address space and a persistent memory physical address space within a volatile memory, wherein the volatile memory is communicatively coupled to a non-volatile store, and wherein the persistent memory unit is powered by a storage source that provides for transfer of data from the volatile memory to the non-volatile store.

14. The system of claim 13, further including a central processing unit communicatively coupled to the volatile memory and the non-volatile store, wherein the central processing unit initiates transfer of data from the volatile memory to the non-volatile store.

15. The system of claim 13, wherein the storage source contains sufficient power to initiate and conclude transfer of data from the volatile memory to the non-volatile store.

16. The system of claim 13, wherein the plurality of processor nodes includes a plurality of central processing units.

17. The system of claim 13, wherein the communication link is selected from a group consisting of a network and a bus.

18. The system of claim 17, wherein the network is selected from a group consisting of a system area network, a ServerNet network, a GigaNet network, an Infiniband network, Infiniband, PCI Express, Ethernet, RDMA-enabled Ethernet, and a Virtual Interface Architecture (VIA) network.

19. The system of claim 18, wherein the system area network is configured to implement remote direct memory access.

20. A method for accessing persistent memory via a communication link, comprising:
initiating a persistent memory command at a processor node, wherein the memory command includes a reference to a persistent memory virtual address;
communicating the persistent memory command to a persistent memory unit via the communication link;
at the persistent memory unit, translating the persistent memory virtual address to a persistent memory physical address within the persistent memory; and
executing the memory command on the contents of the physical address.

21. The method of claim 20, wherein the persistent memory virtual address corresponds to a plurality of persistent memory virtual address spaces and wherein the persistent memory unit further translates the plurality of persistent memory virtual address spaces to persistent memory physical addresses.

22. The method of claim 20, wherein the persistent memory unit confirms that the processor node is authorized to access the persistent memory virtual address.

23. The method of claim 20, wherein the persistent memory command is a read command.

24. The method of claim 20, wherein the persistent memory command is a write command.

25. The method of claim 20, wherein the persistent memory unit opens a range of persistent memory virtual addresses that contains the persistent memory virtual address.

26. The method of claim 20, wherein the processor node includes a central processing unit that initiates the memory command.

27. The method of claim 20, wherein the communication link is selected from a group consisting of a network and a bus.

28. The method of claim 27, wherein the network is selected from a group consisting of a system area network, a ServerNet network, a GigaNet network, an Infiniband network, Infiniband, PCI Express, Ethernet, RDMA-enabled Ethernet, and a Virtual Interface Architecture (VIA) network.

29. The method of claim 28, wherein the system area network is configured to implement remote direct memory access.

30. The method of claim 20, wherein the communication-link-attached persistent memory is selected from a group consisting of magnetic random access memory, magneto-resistive random access memory, polymer ferroelectric random access memory, ovonics unified memory, FLASH memory, and battery backed volatile memory.

31. A computer-readable medium having stored thereon instructions for causing a computer to access persistent memory via a communication link, comprising the steps of:
initiating a persistent memory command at a processor node, wherein the memory command includes a reference to a persistent memory virtual address;
communicating the persistent memory command to a persistent memory unit via the communication link;
at the persistent memory unit, translating the persistent memory virtual address to a persistent memory physical address within the persistent memory; and
executing the memory command on the contents of the physical address.

32. The computer-readable medium of claim 31, wherein the persistent memory virtual address corresponds to a plurality of persistent memory virtual address spaces and wherein the persistent memory unit further translates the plurality of persistent memory virtual address spaces to persistent memory physical addresses.

33. The computer-readable medium of claim 31, wherein the persistent memory unit confirms that the processor node is authorized to access the persistent memory virtual address.

34. The computer-readable medium of claim 31, wherein the persistent memory command is a read command.

35. The computer-readable medium of claim 31, wherein the persistent memory command is a write command.

36. The computer-readable medium of claim 31, wherein the persistent memory unit opens a range of persistent memory virtual addresses that contains the persistent memory virtual address.

37. The computer-readable medium of claim 31, wherein the processor node includes a central processing unit that initiates the memory command.

38. The computer-readable medium of claim 31, wherein the communication link is selected from a group consisting of a network and a bus.

39. The computer-readable medium of claim 38, wherein the network is selected from a group consisting of a system area network, a ServerNet network, a GigaNet network, an Infiniband network, Infiniband, PCI Express, Ethernet, RDMA-enabled Ethernet, and a Virtual Interface Architecture (VIA) network.

40. The computer-readable medium of claim 39, wherein the system area network is configured to implement remote direct memory access.

41. The computer-readable medium of claim 31, wherein the communication-link-attached persistent memory is selected from a group consisting of magnetic random access memory, magneto-resistive random access memory, polymer ferroelectric random access memory, ovonics unified memory, FLASH memory, and battery backed volatile memory.
